(19) United States
(12) Patent Application Publication
(10) Pub. No.: US 2006/0013235 A1
(43) Pub. Date: Jan. 19, 2006

(54) Wireless terminal dynamically programmable proxies

(75) Inventor: Timothy David Farnham, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/110,730

(22) Filed: Apr. 21, 2005

(30) Foreign Application Priority Data
Jun. 15, 2004 (GB) 0413369.0

(51) Int. Cl. H04L 12/28

(52) U.S. Cl. 370/401

(57) ABSTRACT

The present invention relates to scheduling, compression and transcoding of data content for mobile terminals with limited resources. The present invention provides a method of transferring information or content to or from a terminal dependent on a number of parameters associated with the terminal. Such parameters might include its battery level, processing resource status and memory resource status, and the nature of its connection(s) to the network(s) (network performance). Thus for example a terminal with plenty of processor resources but a single narrowband wireless link may implement a high compression ratio in order to improve the file transfer time to the terminal, even if this requires a high de-compression processing overhead. Such a set-up may be changed during a connection session, for example if the battery runs low necessitating reduced processing. In preferred embodiments this method of transferring content is implemented using a programmable or dynamically adaptable proxy device which adjusts the transcoding and/or compression, as well as its scheduling or rate and timing of transfer of the transcoded/compressed information to and from the terminal over one or more network connections.

### FIELD OF THE INVENTION

The present invention relates to scheduling, compression and transcoding of data content for mobile terminals with limited resources.

### BACKGROUND OF THE INVENTION

Web pages and other multimedia services are becoming increasingly sophisticated or rich in content, for example using large graphics files such as GIF images or FLASH animation, and even Real Player video clips for example, as well as automated procedures such as Java applets. The resulting web page can then be a large object which must be forwarded from the web page server to a requesting client machine. The increasing use of broadband internet connections can support such rich media content, however many other clients are based on machines having limited resources, both in terms of internal processing power and battery life, as well as its connection to the internet which may be over a narrow band wireless connection for example.

An example of a limited resource terminal is a mobile phone, which has limited battery life, limited processing power and memory size, as well as a relatively narrowband connection (eg GSM) to the Internet. These limited resources make it difficult for the terminal to adequately support the above described rich media content. For example, many of the above described graphics files are compressed to reduce their size, however this requires decompression processing by the terminal. A rich media HTML page might require 1-2 MIPS (million instructions per second) of processing. This clearly requires a minimum threshold of processing power and memory to adequately support this. In addition it has been estimated that 100 g of modern battery weight provides about 5×10⁸ instructions, resulting in such a battery discharging after 8 minutes of use providing web-browsing.

This problem has been addressed with the use of transcoding proxy servers or gateways which convert or transcode objects in one representation or format to another. A schematic of such a system for WAP enabled mobiles is shown in FIG. 1. The transcoded object will typically be smaller, and more suited to processing and display by the mobile terminal. For example some of the content may be removed, such as video clips, whilst retaining the semantic information—in other words a simple text only representation of the original rich media page may be rendered on the mobile device. This allows terminals with limited processing capabilities to still access the basic information provided on the web page. The reduced processing load, for example lack of decompression processing, also reduces drain on the battery. A further benefit is that the information consumes less network resource and can be transferred faster to the device over a narrowband link than the original full content object.

Transcoder proxies are described in more detail in U.S. Pat. No. 6,535,922, and Han et al, IBM Thomas J. Watson Research Center; “Dynamic adaptation in an image transcoding proxy for mobile web browsing”; IEEE Personal Communications magazine, December 1998. This includes considerations such as whether to transcode and/or compress at all as there are some situations where it does not improve performance. This requires estimation of the time required to transcode, predicting the size of the transcoded file, and the time required to download the transcoded and original files.

As discussed in Han et al, the decision whether to transcode/compress or not can be based on a number of different criteria. For example this can be based on the predicted improvement in response time with the estimated link speed—see FIG. 4 of Han. Alternatively the decision can be based on providing a uniform delivery of data units in a streaming application—see FIG. 10 of Han. In a further alternative, the decision to compress can be based on the data block size and the estimated compression latency or delay caused.

The third generation cellular air interface standard known as UMTS includes a mechanism (Robust Header Compression, or ROCH) to vary the type of packet header compression used depending on the traffic payload. The header compression operates on knowledge of the packet header structures for predominantly IP and video based applications.

“Video quality evaluation for wireless transmission with robust header compression”, F. Fitzek, S. Hendrata, P. Seeling, M. Reisslein Acticom-03-003 Technical Report discloses this approach which is specific to header compression, and in which both compressor and decompressor hold state information about the packet headers. This avoids having to keep sending certain “repeated” information. For example a sequence number is not sent as both compressor and decompressor know that it increments in a certain manner in successive packets (for example sequentially). This achieves a high compression ratio but is susceptible to errors. For example if a packet is lost then the assumption about sequence number is invalid and the reconstructed packet is different to the original. Therefore, fallback states are required to re-establish the correct assumptions, but to achieve this requires some retransmissions and so loss of compression ratio. The level of compression needs to be tailored to the robustness (error characteristics) of the connection, and this is dynamically varied. This is similar to an MPEG2 compression algorithm in which if a base frame is lost all the predictive frames are meaningless and error propagation occurs resulting in many successive error prone frames until the next base frame is received successfully. Usually the number of predictive frames per base frame is statically fixed by the decompressor but this could be dynamically varied to provide more or less immunity to errors.

Conventional packet compression schemes within protocols such as the popular Point-to-Point Protocol (PPP) use payload based compression in addition to header compression. The packet payload compression algorithms are negotiated at connection establishment and are normally based on Huffman encoding of packets before sending and the reverse process is performed at the receiving end. Each packet payload is compressed on a per packet basis and so it is commonly known that shorter packets or packets containing already compressed data (such as graphical data) have lower compression ratios than longer packets or packets that are not previously compressed at a higher layer. IP based compression using different algorithms (such as LZW77 or LZW78) is described in IETF RFC 2393—see the Internet Engineering Task Force Web Site at: http://www.ietf.org/. This type of payload compression does not compress the packet header information (which can be compressed using special header compression algorithms e.g. Van Jacobson), but instead acts on a packet payload and so small packets may generally not be compressed at all (as otherwise they may be larger than the original packet). The IP Compression Control Protocol (CCP) is described in IETF RFC 1962 and can allow for combining packets within a link layer frame, but this does not include methods of combining packet scheduling and compression to achieve higher compression ratios.

Compression schemes can also be used at the presentation and application layers where in-depth knowledge is available about the content. This leads to application specific (or traffic type specific) solutions that are not always supported, or may not be optimal for the client devices and so transcoding proxies are introduced. For example the standard Hypertext Transfer Protocol (HTTP) does not dynamically perform compression of HTML pages but the graphical images, or video/audio data embedded in the pages are apriori compressed using different algorithms (jpeg, png, gif, mpeg, mp3 etc.). Compressed HTML or CHTML that supports GZIP compressed HTML pages rather than raw HTML is coded into the latest server and browser software, but the decompression is implemented within the browser software and so this may not be optimally implemented for a particular target platform. Therefore these different compression schemes must be supported by the client browser (or browser plug-ins) in order for the decompression to be performed and the data retrieved. Also, from the content point of view the compression formats, will be selected during the web site development in order to provide the best combination of quality and compressed size for the most popular general browsers and the most common access method (e.g. dial-up connection or broadband Internet access). Certain rules of thumb exist such as having no more than 25 kbytes of images per page, but these are not necessarily applicable to all device types accessing the content over different networks.

The Wireless Application Protocol (WAP) uses a gateway device to perform compression of WAP content into a WAP specific compressed byte format, but only specific sets of compressed formats are supported and content must be provided in a specific WML format.

Within the Session Initiation Protocol (SIP) a Signal Compression scheme is defined that utilises a Universal Decompression Virtual Machine (UDVM) that can be configured appropriately (with byte code) that enables the appropriate decompression to be performed on signal packets without needing to have a specific set of decompression algorithms specified. However, this concept does not include the specification of a Universal Compression Virtual Machine (UCVM), as compression is generally a more computationally intensive and complex process. This allows a degree of flexibility in what decompression algorithm is used as the decoder can be programmed at the beginning of a session (using the UDVM), without the need to have a common agreed set of algorithms pre-programmed in the decoder implementation.

### SUMMARY OF THE INVENTION

In general terms the present invention provides a method of transferring information or content by changing the format of that content when transferred to or from a terminal dependent on a number of performance parameters associated with the terminal and/or its service provider, or more generally network including for example a wireless base station coupled to the Internet. Such performance parameters might include the terminal performance parameters such as the terminal's battery level, processing and memory resources, as well as network performance parameters such as latency and throughput. Thus for example a mobile phone having low processor resources may be able to provide a better web content rendering service by operating with limited decompression processing, even if this means a low level (eg text only) rendering of the original content. On the other hand a terminal with plenty of processor resources but a narrowband wireless link may be better off with a high compression ratio in order to improve the file transfer time to the terminal, even if this requires a high decompression processing overhead.

The content format conversion may be changed during a connection session, for example if the terminal's battery runs low necessitating reduced processing, or the network resources such as latency and throughput reduce, requiring an increase in compression processing to compensate. This is not limited to changing the operating parameters of a specific standard codec as in existing approaches, but allows the complete switch from one compression and scheduling scheme to another. It also permits the intelligence that performs the scheduling of the compression and transmission of frames to be implemented in a proxy device and therefore relieves the terminal of having to make decisions regarding which description to request and when. This eliminates a problem that can occur in existing approaches in that the request for the next frame is made after the previous frame has been received and so the latency to return the request back to the server and then send the next frame to the terminal may be longer than the required deadline. This is avoided in the present arrangement by having a network resident programmable proxy incorporating scheduling functionality that takes into account the network(s) performance and the terminal resource availability.

The transfer method may be selected from one of several available modes, or it may be dynamically adapted as conditions change. The transfer method comprises a number of transmission parameters or variables including different transcoding and/or compression algorithms and scheduling schemes, which can be used with or without a standardised set of agreed algorithms. Additionally link parameters may be altered which when combined with altering the other transmission parameters enhances the content format changes. For example the link rate may be increased using higher order modulation at the risk of increased errors, or the link may be switched from GSM to IEEE802.11 WLAN for example.

In preferred embodiments this method of transferring content is implemented using a programmable or dynamically adaptable network resident proxy device and/or mobile terminal which adjusts its transcoding and/or compression, as well as its scheduling or rate and timing of transfer of the transcoded/compressed information to the terminal and/or proxy device. The proxy device may in one embodiment reside at the end-system (content provider) but may also reside at other points along the path to the mobile device.

By adapting the transfer method variables or transmission parameters according to changing conditions for example battery running low or increased network latency, the performance of the terminal in rendering the original content is optimised. The way in which the performance is optimised may also depend on the type of data transferred (eg video conference or video file for playback) and/or user preferences (eg to maximise battery life due to a long journey between battery charges).

In particular in one aspect there is provided a proxy apparatus according to claim 1.

There is also provide a method of operating a proxy apparatus according to claim 32.

In particular in another aspect there is provided a terminal device according to claim 16.

There is also provided a method of operating a terminal device according to claim 43. The phrase modifying the content format is intended to refer to modifying the representation of the content (the information) independent of the data communication protocol used to convey it. Examples of such format changes include compression, decompression, transcoding, and/or removal of some content

The terms transcoding and compression are used interchangeably throughout the specification, and refer generally to changing information from one format to another, for example removing graphics from a web page, then compressing this data so that it is suitable for a limited resource terminal such as a mobile phone for example. More generally, encoding is also used to refer to transcoding and compression.

The performance parameters used to adapt the compression schemes relate to the operating environment of the terminal and effect the transfer of the content. Such parameters include terminal specific parameters such as battery level, processing and memory resource levels, as well as network based parameters such as network latency and throughput.

The transmission parameters relate to the method of transferring the content such as the compression ratio and/or transcoding algorithms, and scheduling information such as transmission rate (parameters relating to periodicity of scheduling events and maximum latency targets) of the encoded packets onto the network.

These arrangements overcome a problem identified by the inventor in which current systems have their compression and/or transcoding (and also scheduling) set at design or installation time and are aimed at the worst case scenario for a particular network access mode, for example terminals with the lowest available processing power using a certain air interface standard. The arrangements defined above provide flexibility, allowing transmission parameters to be optimised for a particular terminal depending on its current operating environment.

Further, the variation in compression scheme is not simply related to changes in wireless link parameters such as error rate, but instead is related to terminal specific conditions such as battery level and/or network specific conditions such as latency and packet loss probability. It may also be related to other wireless link parameters such as estimated bandwidth, latency, latency variation, radio link transmission schedules. It also supports the multi-mode terminal operation in which more than one active wireless technology is utilised simultaneously.

Furthermore, in embodiments where the terminal controls (by programming the proxy scheduling and compression functionality) the transmission parameters, it is able to optimise the content format conversion carried out by the proxy for its own current operating conditions, rather than relying on a third party such as the base station or a proxy device not controlled directly or indirectly by the terminal.

In general terms in another aspect there is provided a system for transferring content from a content provider to a user device via a proxy apparatus which converts the content for consumption by the user device. This conversion may involve encoding content packets received from the provider, by for example transcoding and/or compressing these before forwarding to the user device. The user device is configured to provide a feedback link to the proxy apparatus in order to signal the proxy to change the conversion. This allows the user device to adapt the received (converted) content in order to optimise various factors such as its use of its own resources, the display or rendering of the content on the user device, and/or use of the communications link between the content provider and the user device.

The communications link will typically include a wireless link between the user device and a wireless service provider. In addition to the feedback induced content conversion changes, the wireless service provider may additionally adjust certain wireless link transmission parameters such as the modulation rate in order to improve the bandwidth of the link. The user device can respond to this by adjusting the content conversion to take advantage of this extra bandwidth.

In general terms in another aspect there is provided a system for transferring content from a content provider to a user device via a proxy apparatus which converts the content for consumption by the user device. This conversion may involve encoding content packets received from the provider, by for example transcoding and/or compressing these before forwarding to the user device. A software controller is employed in the user device and/or the proxy apparatus in order to download software modules for implementing different conversions. The controller may also upload modules stored locally, for example in order to forward an appropriate decompressor module corresponding to the compressor module to be utilised by the proxy apparatus. The conversion used is preferably updated dynamically as conditions on the link between the content provider and the user device change. The software controller implementing the appropriate software modules as the conversion requirements change.

### BRIEF DESCRIPTION OF THE DRAWINGS

Embodiments are described with reference to the drawings, by way of example only and without intending to be limiting, in which:

FIG. 1 shows a WAP transcoder proxy arrangement for a mobile phone;

FIG. 2 shows a dynamic transcoder proxy arrangement for a wireless terminal according to an embodiment;

FIG. 3 shows a method of determining an appropriate setting for the dynamic proxy of FIG. 2 for a particular terminal;

FIG. 4 shows a schematic of a dynamic proxy according to an embodiment;

FIG. 5 shows a method of operation of the scheduler function in the proxy of FIG. 4;

FIG. 6 shows a method of operation of the proxy controller function in the proxy of FIG. 4;

FIG. 7 illustrates a process for setting up a connection session between a terminal and a proxy according to an embodiment;

FIG. 8 shows a dynamic transcoder proxy arrangement for a wireless terminal according to another embodiment; and

FIG. 9 shows a dynamic transcoder proxy arrangement for a wireless terminal according to an embodiment;

FIG. 10 is a flow chart showing the operation of a terminal according to an embodiment.

### DETAILED DESCRIPTION

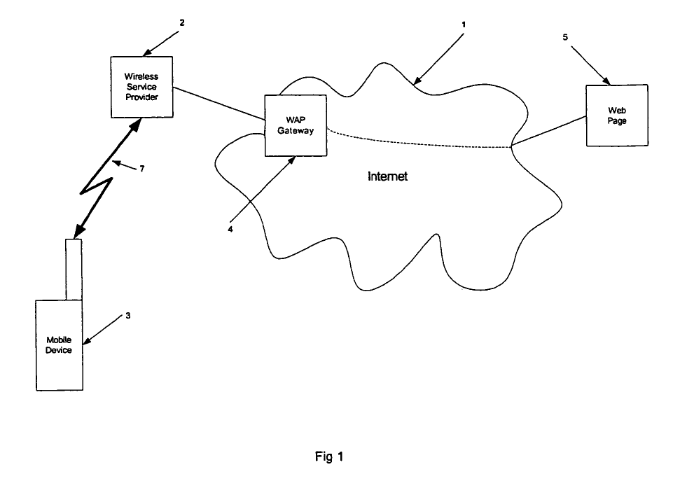

FIG. 1 shows a known type of communications system having a network 1 such as the Internet, a wireless service provider 2 connected to the network 1, and a mobile terminal 3 coupled wirelessly to the wireless service provider 2. The mobile terminal 3 is typically a mobile phone with WAP (wireless application protocol) capabilities which allow for limited retrieval of web page information from the Internet 1. The mobile terminal 3 accesses a web page 5 through the wireless service provider 2 and the Internet 1, however the web page content is transcoded by a WAP gateway device 4 into a compressed format so that this can be received and displayed by the mobile terminal 3 which has limited wireless bandwidth and display capabilities.

Such a system is limited and inflexible however, as more powerful mobile terminals are still restricted to the basic WAP service, and cannot take advantage of their greater processing capabilities for example to display different picture qualities using different content formats. On the other hand where more sophisticated systems can be envisioned that provide additional compression for example, this may not be suitable in cases where the terminal is running low on battery power and a reduced level of performance to accommodate this would be desirable.

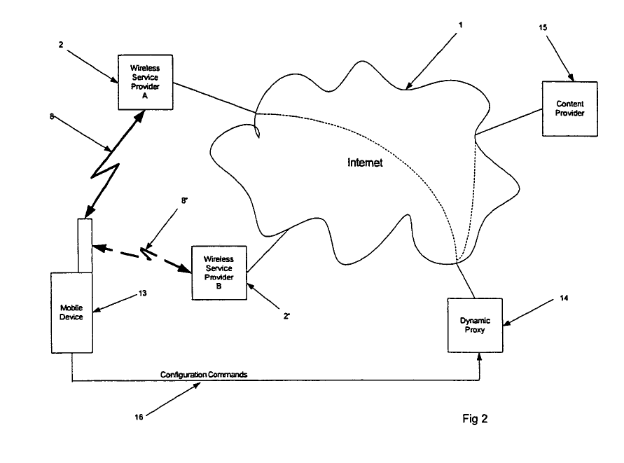

Referring to FIG. 2, a communications system according to a first embodiment is shown. The system also comprises a network 1 such as the Internet, a wireless service provider 2, and a content provider 15 containing content (eg web page or video stream) desired by the user of a modified mobile terminal 13. The system also comprises a dynamic transcoding proxy device 14 connected to the network 1.

As with the system of FIG. 1, the content of the web page, email server, video server or other content provider 15 is forwarded first to the transcoding proxy 14 which processes this prior to forwarding onto the wireless service provider 2 and ultimately the mobile terminal 13. The transcoding proxy 14 is not limited to a set transcoding algorithm as in the case of the WAP system of FIG. 1, but instead has a number of algorithms which may be dynamically programmed depending on the capabilities of the terminal 13. The terminal 13 instructs the proxy 14 to use one of a number of predetermined algorithms or a specified algorithm code implementation (for example identified by URL and implemented in for example Java byte code) based on terminal performance parameters such as battery level, wireless connection (8) capacity, processing and memory capacity. Thus configuration commands 16 are sent to the proxy 14 from the terminal 13 for example over the wireless link 8 and the Internet 1.

The proxy device 14 has a number of algorithms associated with a number of transmission parameters, thus for example one algorithm may provide a high degree of compression which might be suitable when a terminal 13 has high levels of processing and battery power, but a narrowband wireless channel. In this case large files can be compressed and sent relatively quickly over the wireless channel to the terminal 13. On the other hand, if a situation occurs in which a terminal 13 has a large bandwidth wireless link 8 such as IEEE802.11g WLAN, but low processing and/or battery levels, will benefit from a different algorithm. For example large files can be sent without or with low compression over the high capacity channel 8 to the terminal 13, which can then manage with limited processing to provide these to the user.

The power consumption resulting from the transmitting/receiving of the uncompressed file must be balanced against the difference between the power saving if it were compressed and the power consumption required for decompression. For example in 802.11a at separation of less than 30 m the power consumption for transmission is less than 50 nJ per data (payload) bit. Therefore, if the compression ratio for the chosen algorithm is r the decompression processing power consumption must be less than 50*(1−r) nJ per bit in order to select this compression scheme. This will govern which algorithm is used and this can be dynamically configured in for example General Purpose Processor (GPP), Field Programmable Gate Array (FPGA) or even hard coded ASIC based implementations. If the terminal is receiving the files (rather than transmitting) then the power consumption will be less (for example 25 nJ per bit) and in this case the decompression processing power consumption must be less than 25*(1−r) nJ per bit in order to select the scheme, This also is assuming that compression and decompression latency is acceptable when offset against the reduction in network transfer latency. For example, it the network latency is estimated at N ns per bit then the compression and decompression latency must be less than N*(1−r) ns per bit in order to have latency benefit in using compression.

The configuration commands 16 can be forwarded to the proxy device 14 as part of a connection or session set-up sequence, the algorithm used by the proxy then being fixed for the duration of the connection session. More preferably the terminal 13 is arranged to forward configuration and status commands to the proxy device 14 during the connection session to allow for dynamically changing the transmission parameters (compression level and scheduling of when compression occurs for example) of the session. This is advantageous where the terminal performance parameters change during the connection session with the wireless service provider 2. For example as the battery level runs down, or if the wireless connection performance changes, perhaps due to fading and interference such that the throughput over the link 8 is reduced. Thus the operation of the proxy device 14 can be tailored to real-time conditions associated with the terminal 13 in order to optimise its retrieval of the content of the content provider 15. This could also include feedback to retransmit a previously sent frame of data in an alternative compression format.

The terminal parameters may also be dependent on the wireless service provider 2 or 2′ selected. For example as shown in FIG. 2, the mobile device 13 may select between a first wireless service provider (A) 2, and a second wireless service provider (B) 2′. These might be a cellular GSM connection and a WLAN 802.11g connection for example. In this case the wireless connection capacity terminal parameter will depend on the service provider 2 or 2′ chosen. This may in turn affect the transmission parameter or transcoding algorithm.

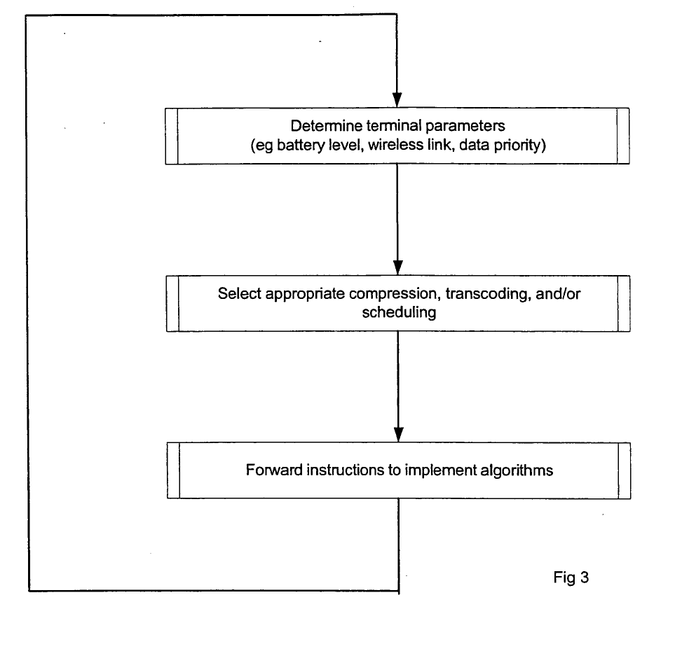

The general method of the embodiment of FIG. 2 is illustrated in FIG. 3. The terminal parameters are first determined; for example the terminal 13 detects its current battery level, processing and memory capabilities and wireless link capacity and makes these available. Based on these terminal parameters, suitable transmission parameters are selected, for example and the compression scheme selected and the algorithm programmed in the proxy device 14. Corresponding configuration commands are then sent to the proxy 14 to configure this compression functionality including both when and how to perform compression. The various aspects of the described functional steps can be located in various hardware, for example all of these may be implemented in software on a general purpose processor or programmable logic executed in the terminal 13, resulting simply in the appropriate configuration commands 16 being sent to the proxy 14. Alternatively, the terminal capability and resource status gathering functionality might be resident in the terminal 13, and the algorithm selection in the proxy device 14 or other intelligence coupled to it. In which case the terminal will then be sent appropriate configuration commands to set up the necessary decompression algorithms and resources.

In addition to changing format (eg compression type) of the content, the modulation or other link specific parameters can also be changed to optimise the content transfer.

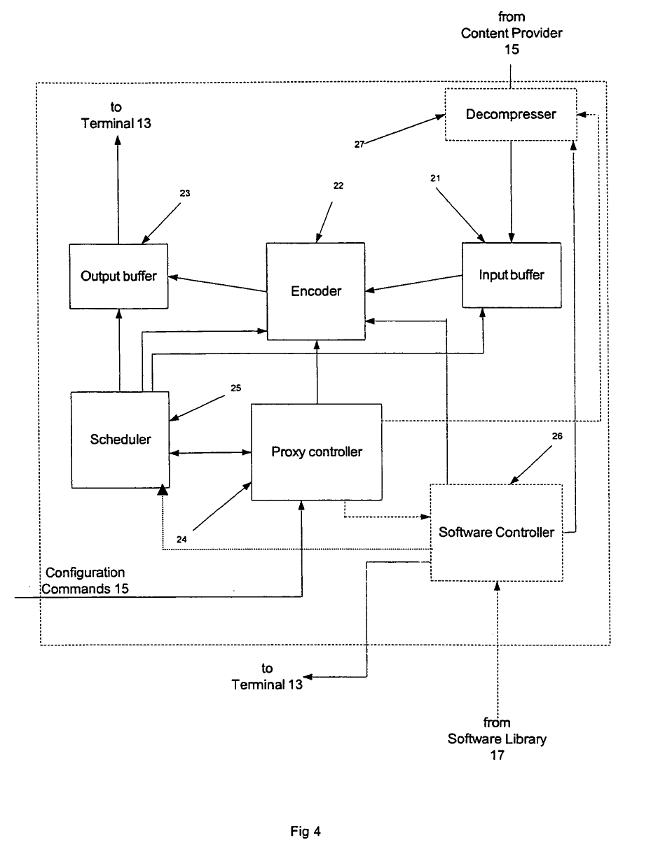

FIG. 4 shows an example architecture of a proxy device 14 and comprises an input buffer 21, a transcoder processing block or encoder 22, an output buffer 23, a proxy controller 24 and a scheduler 25. The proxy 14 may also comprise a software controller 26 to download transcoding and/or compression code for use in the encoder processing block 22. Additionally the proxy device may comprise a decompressor 27 for decompressing compressed packets from the service provider 15 into a “neutral” format to facilitate the proxy's own compression and/or transcoding.

The proxy receives packets (carrying for example video frames) over the network 1 from a content provider 15 such as a video stream. The frames are decompressed by the decompressor 27 and stored in the input buffer 21 in the order received as is known. The buffered frames are passed on to the encoder processing block 22 in a controlled manner according to instructions received from the scheduler 25. The input buffer 21 may operate in a circular fashion. If the rate of frames received by the input buffer 21 exceeds the rate at which these are removed, then the buffer will overwrite other frames and some frames will be lost (dropped). The input buffer 21 can be configured by the scheduler 25 to drop specified frames, for example every second frame. This might occur when the scheduler 25 “knows” that the terminal 13 can only accept a slower rate of frames so that some form of reducing the number of frames passed on is required. The scheduler 25 may also configure the input buffer 21 to first store a predetermined number of frames before passing these to the encoder 22. This may occur because the encoder 22 uses a compression algorithm which requires a block of frames rather than on a frame per frame basis (such as MPEG2). Also, the frames stored in the input buffer 21 may be retained within the buffer even after being passed to the encoder 22 in order to permit the same frame being passed to the encoder 22 again using a different compression format when instructed by the scheduler 25.

The encoder processing block 22 implements a compression and/or transcoder algorithm suitable for converting the current packet inflow from the content provider 15 into a different packet outflow suitable for the terminal 13. The encoder block 22 may implement one of a number of predetermined algorithms as instructed by the proxy controller 24. The particular algorithm used may change over the course of the connection with the terminal 13 as terminal parameters change, for example the wireless link bandwidth or the level of processing resource in the terminal 13. A variety of algorithms may be stored in the proxy device 14, or they may be downloaded as needed by the software controller 26; for example from a software library 17. The algorithms may also be configured on the fly where this option is available.

The encoder processing block 22 converts the frames received from the input buffer 21 into “new” frames which are passed onto the transmission or output buffer 23. The packets received from the encoder processing block 22 are stored or buffered by the output buffer 23, and then forwarded to the terminal 13 at a rate and at instances in time instructed by the scheduler 25.

Preferably the scheduler 25 is arranged to instruct the input buffer 21 to transfer packets to the encoder 22 only when required by the processing rate of the output buffer 23, which is in turn dependent on the terminal parameters. This avoids any unnecessary encoding by the encoder block 22 of frames that might otherwise have been dropped. Also, if necessary, the scheduler 25 has the capability to instruct the same frame (held in the input buffer 21) to be encoded (by the encoder 25) and storing in the output buffer 23 in two or more different content formats for passing over the same or different networks to the terminal 13 based on feedback from the terminal.

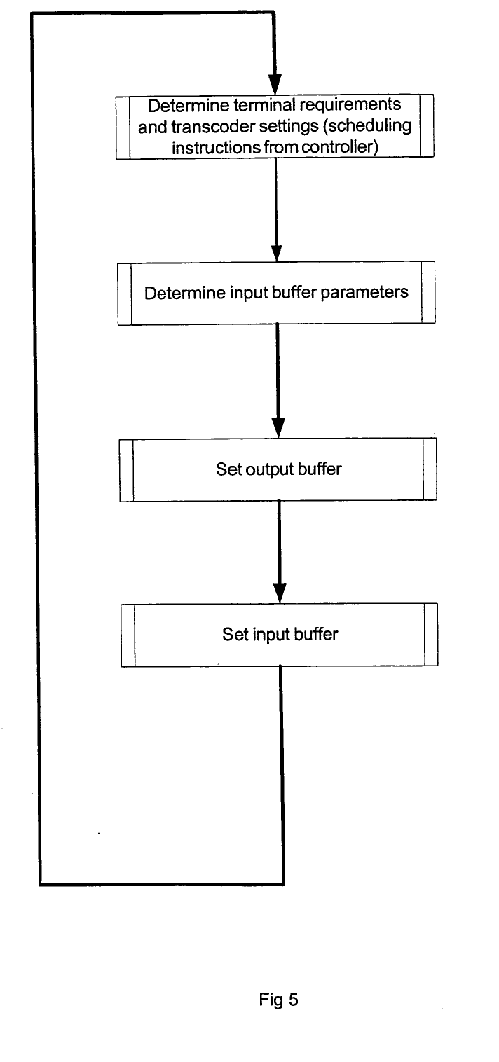

The scheduler 25 therefore controls the dropping of packets in the input buffer 21, as well as serving the buffer and forwarding to the encoder 22 from the input buffer 21. It can also control the transmission of packets from the output buffer 23 to the terminal 13 over the appropriate network (selecting the appropriate network connection). The output rate of the output buffer 23 to the terminal 13 is effectively set by the rate at which frames or packets are forwarded from the input buffer 21 to the encoder 22 for encoding. The scheduler 25 receives instructions from the controller 24 regarding the transmission schedules to the terminal 13, and then serves the input and output buffers 21 and 23 accordingly. A flow chart showing this is illustrated in FIG. 5.

The scheduler 25 receives a terminal transmission schedule from the controller 24, as well as other necessary information such as the processing time of the decompression at the terminal (processing rate at terminal) and encoder processing blocks 22 (processing rate at proxy), the amount of data or frames the encoder input requires per operation and the amount of data or packets delivered, network performance estimates (error rate, latency and throughput) for each available network connection. The scheduler 25 then determines information from the designated input buffer 21 including the approximate (or actual) rate of receiving packets from the content provider 15 for example the RSVP protocol can be used to negotiate throughput, the buffer size and current occupancy. From this the scheduler 25 can set the output buffer size and determine when to schedule transmission to the appropriate network, the input buffer service rate and schedule (to the encoder 22), as well as a packet deletion or dropping setting if appropriate. These settings can be changed dynamically for each traffic flow within a session to the terminal 13 according to instructions received by the controller 24. Thus the scheduler 25 instructs when to use the algorithm (i.e. perform coding) and when to send the coded packets to the terminal device.

If the scheduler knows it will take a particular point in time 40 ms to decode a particular block of data (of a particular size and compression type) within a traffic stream then a feedback signal is only necessary when the terminal resources change or an unexpected event occurs (such as packet corruption or loss) and then the scheduler must be told that it will now take 50 ms for instance. Likewise if the network latency is 20 ms per frame then this can also be taken into account by the scheduler 25 to determine when to compress the next block so that there is minimal buffered compressed packets and so overall latency of getting the decompressed data to the application (based the target performance requirement) is acceptable.

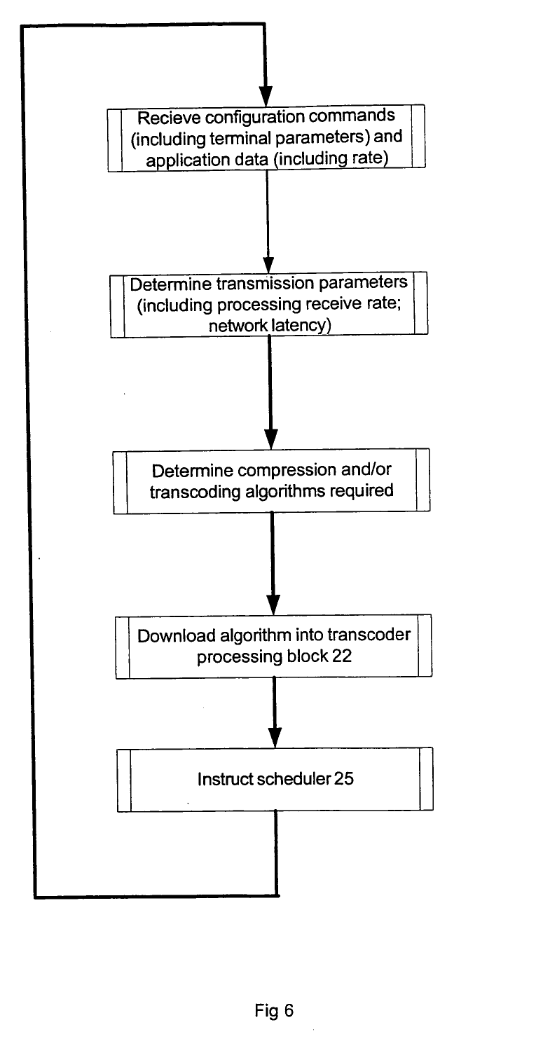

The proxy controller 24 receives control or configuration commands 16 from the terminal 13 which include terminal parameters or settings such as a wireless network performance e.g. error rate, latency and throughput, current resource status (processing and memory capacity and battery level), as well as the type of application the session will support. The type of application relates to the type of content the content provider 15 is supplying within a particular traffic flow, and may simply relate to general web traffic, or image traffic, file transfer, video streaming or voice over IP calls. From this information the controller 24 determines a number of transmission parameters such as a latency and throughput between the proxy 14 and terminal 13, and a level of compression or coding required. From the compression and/or coding requirement, as well as the terminal processing rate or scheduling requirements, the controller 24 selects an appropriate compression and/or coding algorithms which are implemented by the encoder processing block 22. This may be software code stored in a local library 26, or downloaded from a remote location 17. The terminal processing rate and other scheduling parameters such as network latency and throughput distributions are forwarded to the scheduler 25 which configures the input and output buffer 21 and 23 as described above. This process is illustrated in FIG. 6.

Each terminal-proxy connection will include its own input buffer 21, encoder 22, output buffer 23, and scheduler 25 combinations. The proxy controller 24 will control each of these with instructions to the respective scheduler 25 as well as providing the appropriate algorithm for the respective encoder processing blocks 22.

In an alternative arrangement, determining the transmission parameters from the terminal parameters is performed at the terminal 13. The terminal 13 then forwards configuration commands 16 containing the transmission parameters to the controller 24 which selects and programs the appropriate transcoding and/or compression algorithms and instructs the scheduler 25. In a further arrangement, the configuration commands may simply contain a reference to an algorithm (such as URL to Java byte code) and required scheduling information which the controller 24 passes on to the scheduler 25.

The software controller 26 provides the proxy device 14 with the ability to download transcoder/compression algorithm software modules specified by the configuration commands 16. These may be downloaded from the terminal 13 for example, or from a third party library 17. In a further alternative, the software controller 26 may be instructed to upload software modules from an onboard library and intended for implementation on the terminal 13. In a still further alternative, the transcoder algorithm may simply pass frames from the input buffer 21 to the output buffer 23. This may occur when the received frame rate only needs to be reduced before transmitting to the terminal, so that for example the input buffer 21 is arranged to drop every second frame in a video stream, thereby halving the rate to the terminal 13.

Whilst the embodiments have so far been described with respect to transferring content from the content provider 15 to the terminal 13, there is also often a need to transfer content from the terminal 13 to the content provider 15, for example a two-way video call. In this case encoded packets or frames are received by the proxy device 14 from the terminal 13. the proxy 14 decodes these, for example decompresses and/or transcodes the packets from one format to another, and forwards them to the content provider 15, perhaps using another type of encoding prior to transmission. The type of decoding employed by the proxy 14 can again be specified or determined in an analogous manner to the encoding determinations described above.

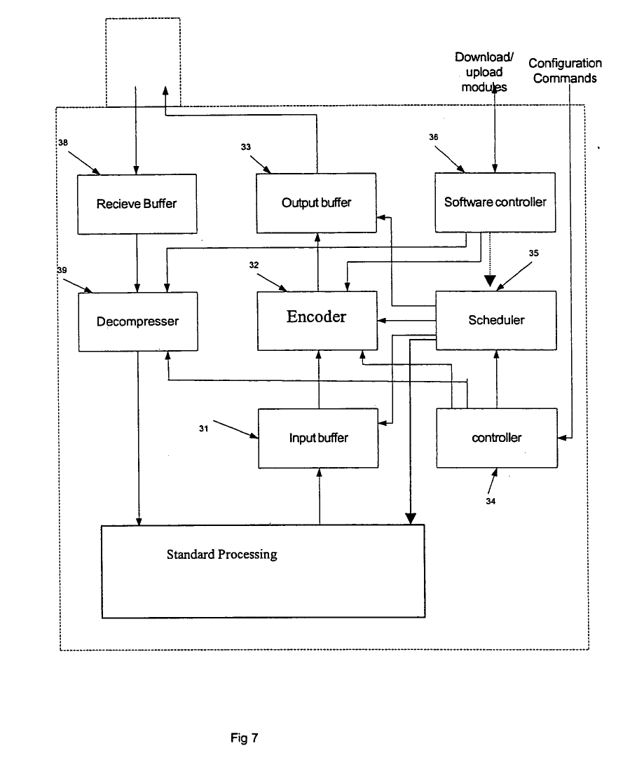

FIG. 7 illustrates an architecture for a terminal 13 which shows both transmitting and receiving processing blocks. The terminal 13 comprises an input buffer 31, an encoder processing block 32, an output buffer 33, a scheduler 35 and a terminal controller 34; all of which are analogous to the corresponding components of the proxy device 14 described above, and respectively the input buffer 21, encoder block 22, output buffer 23, scheduler 25 and proxy controller 24.

In one embodiment, the terminal controller 34 determines the terminal parameters and from this implements an appropriate compression regime as described above. Configuration commands are sent to the proxy device 14 to inform it of the decompression/transcoding algorithms to implement in order to properly receive the content. Alternatively the terminal parameters may be forwarded in the configuration commands to the proxy, which determines the appropriate decoding algorithm to use. The proxy 14 then instructs the terminal controller 34 to implement a defined algorithm which is implemented in the terminal encoder block 32. The encoder algorithm may be code which is stored on the terminal 13 or downloaded from a specified location by a terminal software controller 36.

The terminal controller 34 may also instruct the scheduler 35 to control the input buffer 31 to activate selective frame dropping, as described above for the proxy device 14. additionally or alternatively the controller 34 may implement frame duplication for rate adjustment as already discussed. This is necessary for example if an application is not able to accept a dynamically adapting frame rates.

The terminal additionally comprises a receive buffer 38 and a decoder processing block 39 which receive and decode packets received from the proxy device. The decoder 39 complements the encoder 22 of the proxy device 14, for example decompressing packets knowing the algorithms used by the encoder 22. the encoding/decoding algorithms are agreed between the proxy controller 24 and the terminal controller 34 using configuration commands. The decoded packets are then passed onto the rest of the terminal processing chain or block. A similar arrangement is utilised at the proxy device 14, where encoded packets are received from the terminal 13, decoded and passed on to the content provider 15.

The level of compression is tailored to the terminal's decompression performance. The preferred method is by having the terminal 13 program the compressor/transcoder 22 at the proxy device 14 to minimise the subsequent interaction over the wireless link. Normally compression is at least 10 times more complex than decompression to achieve high compression ratios and so it becomes highly attractive to dynamically change the compression scheme when the compressor is implemented at the terminal 13 to minimise the amount of compression processing in order to meet latency requirements. Ideally also the level of compression should be optimised to the performance of the network(s) being used, as a slow Wide Area Network (WAN) connections like GPRS will consume more power per bit of transmitted data than Local Area Network (LAN) connections over for instance Bluetooth or IEEE802.11, but in both cases the ability to dynamically change the proxy configuration from the status of the network and terminal means that the best scheme is used all of the time. For example one possible solution for a multi-mode terminal is to use a relatively slow but reliable GPRS connection for transmitting base frames within a video stream and the less reliable (deterministic latency) but higher performance and less deterministic WLAN connection for transmitting enhancement layer frames. It is also possible for redundancy to send for example the base layer frames over both WLAN and GPRS connections and the enhancement layer frames just over the WLAN connection.

Examples of applications follow to further illustrate these and other embodiments. For video traffic, the scheduler 25 serves the input buffer 21 and forwards/frames to the encoder 22, which is instructed to encode at a certain frame rate and hence the encoded frames are forwarded to the output buffer and on to the terminal device, for example corresponding to 12 frames per second of video. The scheduler 25 instructs the input buffer 21 or in some implementations the encoder algorithm itself (22) to drop frames when appropriate if the incoming frame rate is higher than the outgoing frame rate. The dropping can be determined by the terminal status, for example frames are dropped when it is expected that the terminal will be too busy to decode them (determined from the processing rate of the terminal), or dropped when the network resources (estimated network latency) are not sufficient to be able to deliver the frame and decode it before the next frame is ready for sending. In addition when multiple network connection between the terminal and proxy exist the output frames from the proxy to the terminal can be sent over different network connections depending on the type of frame and on the performance estimate of the individual network connections.

This arrangement supports the ability to change the network connection or transmission parameters if the terminal parameters change, for example because the battery is running low or the terminal has started another call and so reduces its available bandwidth. This overcomes a disadvantage in known “static” or “fixed” arrangements which can't take advantage of extra capacity or cannot maintain a connection when the connection deteriorates. For example, using 56 kbit/s video encoding that does not adapt to the fact that at one moment in time there could be 100 kbit/s available but 56 kbit/s is the worst case average throughput required for playback and so no adaptation is performed. Packets are then buffered and scheduled for transmission to the terminal assuming that the throughput is greater than or equal to 56 kbit/s otherwise the buffer would simply overflow and packets would be lost (this could be packets corresponding to any point within a frame as a packet will normally carry less than a frame worth of data).

By contrast the embodiment programs the encoding (compression) entity 22 at the proxy 12 dynamically and combines this with the scheduling so that packets are never buffered for very long after the encoding. Extended buffering following encoding is inefficient as the packets could be discarded resulting in a waste of the processing time and processing resource used to compress them. The other facet is that the terminal state is used to control when and how the compression is performed. If the environment is static this is not necessary, but in a dynamic environment the terminal 13 or the different networks resources change over time and so this can be used to control when and how the compression is done and which networks to utilise for transmission to the terminal. For example, suppose the loading on the processor in the terminal 13 is such that the processing rate is 25 per second (i.e. rate of decoding a frame takes 40 ms) to decompress then the scheduler knows not to send the next frame while the previous frame is being decoded (i.e. within 40 ms), but then another application is started and now the processing rate is 20 per second (frame decoding takes 50 ms), then the proxy controller 24 at the proxy 12 takes this into account and reduces the frame rate by dropping frames or reduces the level of compression which reduces the decompression time and increases the processing rate to 25 per second. In addition, if the terminal has different resources set aside for radio transmission/reception and application processing and the application processing is the bottleneck, some of the application processing could be switched to use the resources set aside for the radio communication and vice versa. For example, the same DSP processor could be used for video decompression in addition to modulation and demodulation. This flexibility in terminal processing resource availability can be exploited by reconfiguring the proxy and the frame rate can be increased again to 25 per second.

Conversely, if the network resources become limited because a network activity increases or the terminal is moving into a signal fade, then the network state is also used to control the scheduling so that the transcoder never unnecessarily performs compression for packets to be discarded. Also, the less time critical traffic can be buffered at the input buffer of the proxy 21 for longer prior to compression and a more powerful compression algorithm used thus gaining compression ratio benefits. In this case the video traffic gets priority, but the amount of traffic that can be sent to the terminal is smaller so the frame rate is reduced accordingly and the compression ratio improved by using more powerful algorithms or lower resolution. Alternatively, in the case of multi-mode capable terminal devices two or more network connections can be used simultaneously to achieve higher network throughput at the expense of increased battery power consumption.

In a further example, a 25 frame/s video stream is arriving at the proxy 14 destined for the terminal 13. The terminal 13 is processing and battery power resource constrained and wants to minimise power consumption. The terminal 13 programs the proxy 14 to schedule the transcoding to allow a frame rate of 3 frames/s at a low level of compression to maximise power efficiency as mimimal processing is required at the terminal. Then the terminal 13 is connected to a mains supply or the battery is charged and the proxy 14 is now configured to perform transcoding at 12 frames per second as this is the maximum rate that can be sustained over the current GPRS connection.

A web browsing session is now also started up and the terminal 13 reduces the resolution of the video transcoding and schedules the web traffic to be compressed and sent between every video frame so as to minimise the disruption to the video quality. The web-session also requires good responsiveness but is not as critical as the video and so the web page images are transcoded to a lower resolution and with a higher compression ratio (lower quality) to maintain this responsiveness. Then a WLAN becomes available and now the proxy controller 24 is configured to increase the video frame rate to 25 frames/s and the quality (resolution) is also improved and the web-browsing traffic is no longer compressed or images transcoded to achieve the best quality from the users perspective.

The changing conditions are monitored by the proxy controller 24, which determines appropriate transmission parameters for each traffic flow (video and web browsing), taking into account the effect the connections will have on each other.

These embodiments enable dynamic transcoding/compression and implements scheduling changes required to achieve this. This is preferably achieved by making the proxy entity 14 (which could reside at the end system) and the terminal 13 programmable. This programmability is most easily achieved by having a software download and configuration framework as the terminal status can be used to dynamically program the proxy in a flexible manner without need for standardised set of algorithms and configuration command interactions. In the conventional methods the web site or proxies cannot be dynamically configured (programmed) by the terminal, and so there is limited flexibility. For example, a video service optimised for WinCE™ devices connected via dial-up connection or a WAP phone connected via GPRS is quite specific and not flexible. Programmability allows the terminal 13 to specify exactly how and when the transcoding or compression is done without the need for a previously agreed (i.e. standardised) set of specific algorithms. This is highly attractive for deployment of these types arrangements as the proxy is not as processing resource and memory constrained as the terminal, and so can hold many different algorithm implementations. By contrast the terminal will need to configure itself specifically (with appropriate decoder plug-ins) for each change in scenario, which could increase the specification and cost of the terminal 13.

The proxy 14 allows for buffering and scheduling of compression and transmission operations to optimise for performance and also if necessary to reduce processing and power consumption requirements of the resource constrained terminal. The level of granularity in timing when and which schemes to use can be determined by the terminal (or other decision making entity) depending on application and user preferences. For example, the scheduling function within the terminal can decide (based on terminal context) that due to preference from the user an application for fast responsiveness and current low speed of the wireless connection to suppress all graphical objects over a certain size from being transferred to the terminal in preference for (higher priority) textual objects that are deemed more important.

As it is the terminal that is most resource constrained it is preferred to utilise a programmable proxy device in the network to perform the transmission parameter determining functions and in this case it is not necessary to mandate that the terminal is multi-mode capable, configurable or programmable in any way, although this may be beneficial.

Thus these embodiments relate to the use of protocol flexibility to enable a compression (or transcoding) proxy 14 to schedule transmissions (i.e. store and forward) and compress or transcode data in a combined manner taking into account the requirements and preferences for the different traffic content types and the client (end) device 13 dynamically changing context and the performance of the (wireless) connection(s) 8 or 8′. In this manner an optimised solution can be achieved balancing performance and quality to the user preferences and terminal context.

Preferably the configurable proxy device 14 buffers (in memory) packets destined for the (or each) terminal 13 and decides (based on execution logic residing preferably in the terminal) when to compress (or transcode) and send the combined packet(s) to the terminal using scheduling code. The compression algorithm is also preferably implemented in code provided (or indicated) by the terminal 13 to perform joint compression and scheduling of packets on the proxy device 14. In addition the decompression can be performed in the reverse direction from the terminal to the proxy before the proxy forwards the packets to the network 1 (e.g. Internet).

Optionally the code for performing scheduling, compression and decompression is supplied to the proxy device 14 in Java byte code, or Common Language Runtime (CLR) code. Optionally the proxy device can be located at an access point or base station 2, but preferably in a corporate intranet or network operator premises.

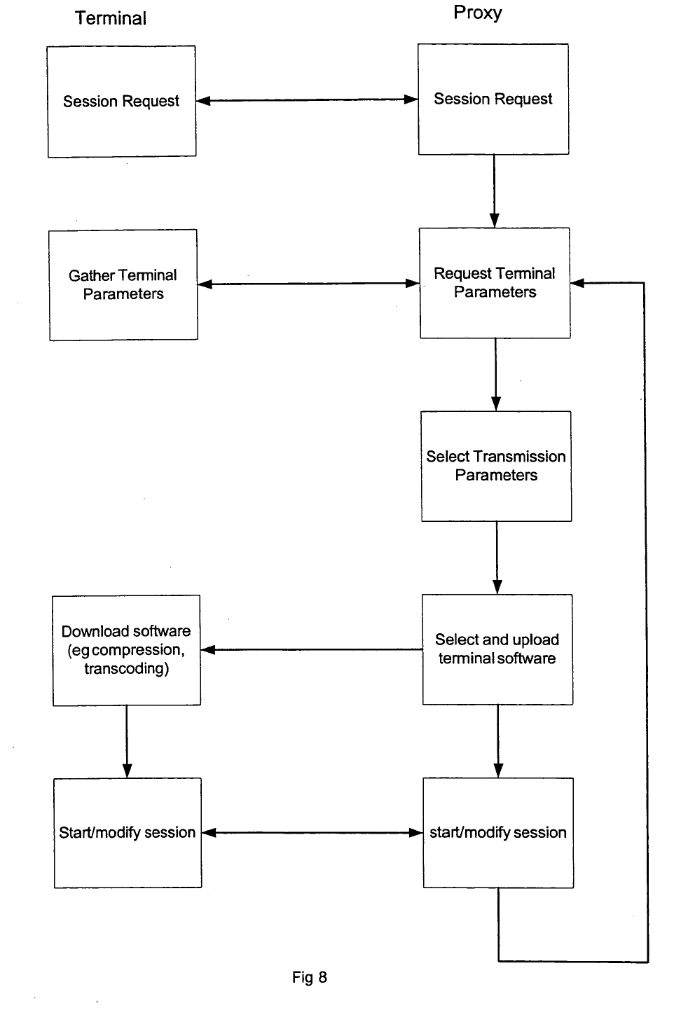

In another embodiment the proxy device can act as the main decision making intelligence and control the terminal compression and scheduling functionality by specifying the code to be downloaded to the terminal. In this case the proxy device must gather generic preference and context information from the terminal in order to decide on the most appropriate scheduling and compression implementation functionality from a suite of program libraries (or web based resources identified by URL). This is illustrated in FIG. 8.

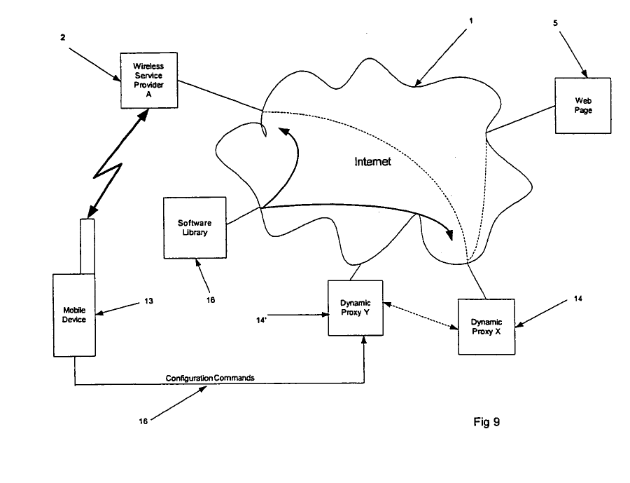

In another embodiment illustrated in FIG. 9, a second proxy device (Y) 14′ is aware of the terminal context and contains the intelligence required to decide on the most appropriate joint compression and scheduling policy. It then selects from a library 17 of possible implementations supported by the terminal type and proxy device performing the compression/decompression. Then suitable terminal and/or proxy software modules are transferred to their respective platforms—the terminal 13 and/or first proxy device (X) 14. In this case information regarding the context of the terminal and the capabilities of the proxy need to be gathered.

The embodiments support the use of data compression algorithms in the general sense (including transcoding) that can be implemented in code (native object code or Java byte code) that acts on the currently buffered data at point of transmission. In addition (and optionally) the buffer can be extended with longer term cache (for example a very large input buffer 21) functionality in both the terminal and proxy. In this case the compression code downloaded to the terminal (and proxy) can contain a compression algorithm that stores data received over a very much longer period of time (limited by memory or secondary storage size) and can use this pool of data when performing compression of data. For example if the same or similar data is transferred at later point in time, a reference to the previous copy held in the buffer is made.

Preferably the embodiments can also support compression format detection and changing algorithms within the compression code. For example to decompress graphical objects previously encoded in JPEG format to PNG format for example.

Optionally the proxy can support combined compression and encryption for enhanced security with minimal additional overhead.

Proxy devices should be trusted and can reside in a corporate intranet if secure sessions are used. This is because encryption will reduce the ability to perform compression at layers beneath the encryption layer. Additional proxy devices can reside in the Network Operator premises for services provided by network operators or service providers associated with them. Mutual authentication of proxy devices and terminals is necessary using for instance a PKI certificate or other means. Then the terminal can program the proxy in the appropriate manner using the specified code, (which also requires validation of origin and authenticity). Then the terminal 13 can route (for example by using the normal proxy settings in web browsers and other Internet applications) all the traffic for a particular service (or application) via the appropriate proxy entity 14 using the most appropriate compression mechanisms. The mechanisms can also be reconfigured dynamically to account for changes in the device context (for instance moving from WLAN hotspot to cellular network etc.)

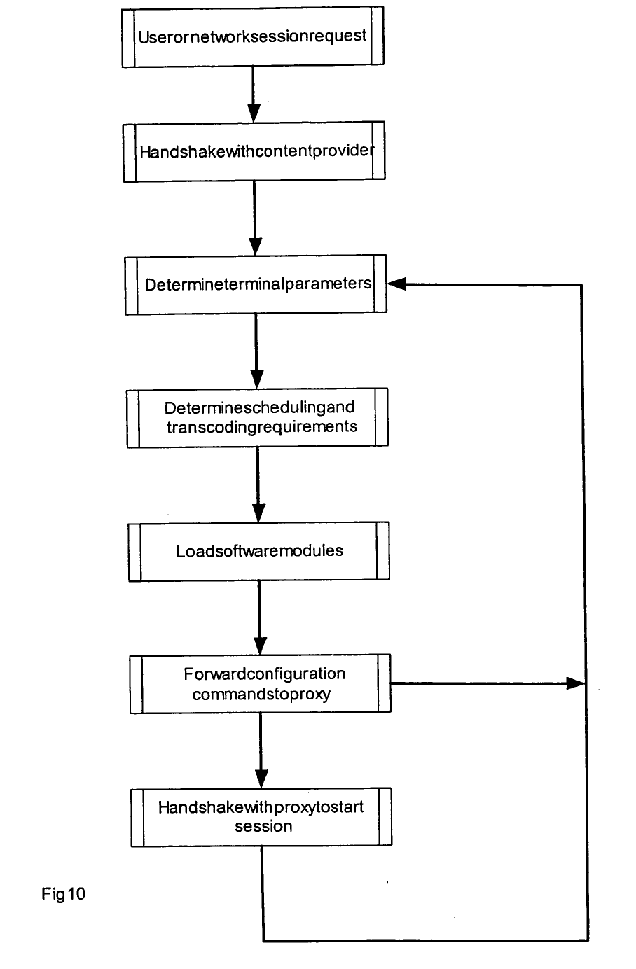

In addition to providing dynamically configurable transcoding and scheduling, known mechanisms can be employed to decide whether or not to transcode/compress at all. For example suitable mechanisms are described in Han et al, IBM Thomas J. Watson Research Center; “Dynamic adaptation in an image transcoding proxy for mobile web browsing”; IEEE Personal Communications magazine, December 1998. The decision making process for transcoding can be based on the predicted improvement in response time (assuming low response time is required) with estimated link speed see the FIG. 4 in this reference. At some link speed it is no longer attractive to transcode or compress. Alternatively, the decision can be based on providing a uniform delivery of data units (assuming a streaming mode of operation) to the end device as shown below—see FIG. 10 of Han.

Whilst a simple terminal can be used in some embodiments which just provides terminal parameters, a more sophisticated terminal can be used to increase system flexibility. FIG. 10 shows a terminal operation flow chart for a fully programmable terminal 13. The terminal 13 receives a session request, for example from the terminal user wanting to make a voice over IP session, browse a web page or receive a video stream. The request could also be from the wireless service provider's access point 2, for example indicating an incoming video session.

The terminal 13 then performs a handshaking protocol with the calling or called entity (for example the content provider 15) in order to determine certain session parameters associated with the other entity. For example its rate of packet transmission across the internet (to the proxy), the amount of data to be transferred, its available compression formats, and other parameters such as encryption schemes which will affect the wireless bandwidth, processing, memory and battery resources of the terminal.

The terminal 13 then determines its own terminal parameters including the available bandwidth, processing, memory and battery resources. From both these sets of information, the terminal 13 determines an appropriate scheduling and transcoding scheme for its internal use—for example receiving 12 frames a second of video, with a certain compression setting. The terminal 13 then downloads the appropriate decompression and scheduling software modules. The terminal 13 then forwards appropriate configuration commands 16 to the proxy 14 in order for the proxy to implement the correct transcoding/compression and transmission scheduling. The proxy device 14 may also download appropriate compression and scheduling software modules in order to achieve this.

Finally, the terminal 13 communicates with the proxy 14 in order to start the session which can all be performed for example using the Session Initiation Protocol (SIP). The terminal continues to monitor its terminal parameters, and if necessary determines new scheduling and transcoding requirements if these change. This is unlikely to involve downloading further scheduling and/or transcoding software modules but may involve reconfiguring the existing ones. It may also involve forwarding further configuration commands to the proxy 14 in order to modify the session or transmission parameters.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A proxy apparatus coupled to a network having a content provider, the proxy apparatus for transferring content between content provider and a terminal device coupled to the network by a link, the proxy apparatus comprising:
means for receiving said content in a first format;
means for determining a performance parameter;
means for modifying said content into a second format dependent on said performance parameter;
means for transmitting said modified content.

2. Apparatus according to claim 1 wherein said performance parameters comprises one or more of the following group: terminal battery level; terminal processing resource status; terminal memory resource status; network error rate, packet loss rate, throughput and/or latency.

3. Apparatus according to claim 1 wherein the link is a wireless link.

4. Apparatus according to claim 1 wherein said modifying means comprises one or a combination of the following: a compression algorithm; a transcoding algorithm; deletion of some of said content in said first format.

5. Apparatus according to claim 1 further comprising means for adjusting a transmission parameter associated with said transmission means.

6. Apparatus according to claim 5 wherein said transmission parameters comprises one or more of the following group: rate of transmitting said modified content; when to transmit said modified content; which network connection(s) to use to transmit modified content.

7. Apparatus according to claim 1 wherein the modified content is transmitted during a connection session, and the second format changes during said session.

8. Apparatus according to claim 1 further comprising means for adjusting a transmission parameter associated with said transmission means, wherein the modified content is transmitted during a connection session, the second format changes during said session, and wherein the transmission parameter changes during said session.

9. Apparatus according to claim 1 further comprising means for adjusting a transmission parameter associated with said transmission means wherein said transmission parameters comprise one or more of the following group: rate of transmitting said modified content; when to transmit said modified content; which network connection(s) to use to transmit modified content, and wherein the modified content is transmitted during a connection session, and the second format changes during said session, and wherein the transmission parameter changes during said session.

10. Apparatus according to claim 1 wherein said receiving means comprises an input buffer, said modifying means comprises an encoder processing block, and said transmitting means comprises an output buffer controlled by a scheduler.

11. Apparatus according to claim 7 further comprising a proxy controller arranged to receive said performance parameter and to select, program or configure a compression or transcoding algorithm for use in the encoder processing block.

12. Apparatus according to claim 10 further comprising a proxy controller arranged to receive instructions to implement a transcoder and/or compression algorithm for use in the encoder processing block.

13. Apparatus according to claim 10 wherein the scheduler further controls the input buffer and/or encoding processing block in order to minimise the amount of modified content pending in said output buffer.

14. Apparatus according to claim 1 further comprising means for downloading and installing software modules in order to implement said content modifying means.

15. Apparatus according to claim 1 further comprising:
means for receiving said content in a third format;
means for modifying said content into a fourth format dependent on said performance parameter;
means for transmitting said modified content.

16. Apparatus according to claim 15 wherein said first and third content formats are the same, and wherein said second and fourth content format are the same.

17. A terminal apparatus for a terminal device coupled to a network by a link, the network having a content provider and the terminal apparatus for transferring content to a proxy device between the content provider and the terminal device, the proxy apparatus comprising:
means for receiving said content in a first format;
means for determining a performance parameter;
means for modifying said content into a second format dependent on said performance parameter;
means for transmitting said modified content.

18. Apparatus according to claim 17 wherein said performance parameters comprises one or more of the following group: terminal battery level; terminal processing resource status; terminal memory resource status; network throughput and/or latency.

19. Apparatus according to claim 17 wherein the link is a wireless link.

20. Apparatus according to claim 17 wherein said modifying means comprises one or a combination of the following: a compression algorithm; a transcoding algorithm; deletion of some of said content in said first format.

21. Apparatus according to claim 17 further comprising means for adjusting a transmission parameter associated with said transmission means.

22. Apparatus according to claim 21 wherein said transmission parameter comprises one or more of the following group: rate of transmitting said modified content; when to transmit said modified content; network connection(s) to use for transmission of modified content.

23. Apparatus according to claim 17 wherein the modified content is transmitted during a connection session, and the second format changes during said session.

24. Apparatus according to claim 17 further comprising means for adjusting a transmission parameter associated with said transmission means, wherein the modified content is transmitted during a connection session, and, the second format changes during said session, and wherein the transmission parameter changes during said session.

25. Apparatus according to claim 17 further comprising means for adjusting a transmission parameter associated with said transmission means wherein said transmission parameters comprise one or more of the following group: rate of transmitting said modified content; when to transmit said modified content; which network connection(s) to use to transmit modified content, and wherein the modified content is transmitted during a connection session, and the second format changes during said session, and wherein the transmission parameter changes during said session.

26. Apparatus according to claim 17 wherein said receiving means comprises an input buffer, said modifying means comprises an encoder processing block, and said transmitting means comprises an output buffer controlled by a scheduler.

27. Apparatus according to claim 24 further comprising a proxy controller arranged to receive said performance parameter and to select, program or configure a compression or transcoding algorithm for use in the encoder processing block.

28. Apparatus according to claim 26 further comprising a proxy controller arranged to receive instructions to implement a transcoder and/or compression algorithm for use in the encoder processing block.

29. Apparatus according to claim 26 wherein the scheduler further controls the input buffer and/or encoding processing block in order to minimise the amount of modified content pending in said output buffer.

30. Apparatus according to claim 17 further comprising means for downloading and installing software modules in order to implement said content modifying means.

31. Apparatus according to claim 17 further comprising:
means for receiving said content in a third format;
means for modifying said content into a fourth format dependent on said performance parameter;
means for transmitting said modified content.

32. Apparatus according to claim 31 wherein said first and third content format are the same, and wherein said second and fourth content format are the same.

33. A method of operating a proxy apparatus coupled to a network having a content provider, the proxy apparatus for transferring content between content provider and a terminal device coupled to the network by a link, the method comprising:
receiving said content in a first format;
determining a performance parameter;
modifying said content into a second format dependent on said performance parameter;
transmitting said modified content.

34. A method according to claim 33 wherein said performance parameter comprises one or more of the following group: terminal battery level; terminal processing resource status; terminal memory resource status; network error rate, packet loss rate, throughput and/or latency.

35. A method according to claim 33 wherein the link is a wireless link.

36. A method according to claim 33 wherein said modifying step comprises one or a combination of the following: a compression algorithm; a transcoding algorithm; deletion of some of said content in said first format.

37. A method according to claim 33 further comprising adjusting a transmission parameter associated with said transmission means.

38. A method according to claim 37 wherein said transmission parameters comprises one or more of the following group: rate of transmitting said modified content; when to transmit said modified content; which network connection(s) to use to transmit modified content.

39. A method according to claim 33 wherein the modified content is transmitted during a connection session, and the second format changes during said session.

40. A method according to claim 39 when dependent on claim 37 or 38, wherein the transmission parameter changes during said session.

41. A method according to claim 33 further comprising adjusting a transmission parameter associated with said transmission means, wherein the modified content is transmitted during a connection session, and the second format changes during said session, and wherein the transmission parameter changes during said session.

42. A method according to claim 33 further comprising adjusting a transmission parameter associated with said transmission means, wherein said transmission parameters comprises one or more of the following group: rate of transmitting said modified content; when to transmit said modified content; which network connection(s) to use to transmit modified content, and wherein the modified content is transmitted during a connection session, and the second format changes during said session, and wherein the transmission parameter changes during said session.

43. A method according to claim 33 further comprising downloading and installing software modules in order to implement said content modifying step.

44. A method according to claim 33 further comprising:
receiving said content in a third format;
modifying said content into a fourth format dependent on said performance parameter;
transmitting said modified content.

45. A method according to claim 44 wherein said first and third content formats are the same, and wherein said second and fourth content format are the same.

46. A method of operating a terminal apparatus for a terminal device coupled to a network by a link, the network having a content provider and the terminal apparatus for transferring content to a proxy device between the content provider and the terminal device, the method comprising:
receiving said content in a first format;
determining a performance parameter;
modifying said content into a second format dependent on said performance parameter;
transmitting said modified content.

47. A method according to claim 46 wherein said performance parameters comprises one or more of the following group: terminal battery level; terminal processing resource status; terminal memory resource status; network error rate, packet loss rate, throughput and/or latency.

48. A method according to claim 46 wherein the link is a wireless link.

49. A method according to claim 46 wherein said modifying comprises one or a combination of the following: a compression algorithm; a transcoding algorithm; deletion of some of said content in said first format.

50. A method according claim 46 further comprising adjusting a transmission parameter associated with said transmission means.

51. A method according to claim 50 wherein said transmission parameter comprises one or more of the following group: rate of transmitting said modified content; when to transmit said modified content; network connection(s) to use for transmission of modified content.

52. A method according to claim 46 wherein the modified content is transmitted during a connection session, and the second format changes during said session.

53. A method according to claim 46 further comprising adjusting a transmission parameter associated with said transmission means, wherein the modified content is transmitted during a connection session, and the second format changes during said session, and wherein the transmission parameter changes during said session.

54. A method according to claim 46 further comprising adjusting a transmission parameter associated with said transmission means, wherein said transmission parameters comprises one or more of the following group: rate of transmitting said modified content; when to transmit said modified content; which network connection(s) to use to transmit modified content, and wherein the modified content is transmitted during a connection session, and the second format changes during said session, and wherein the transmission parameter changes during said session.

55. A method according to claim 46 further comprising downloading and installing software modules in order to implement said content modifying step.

56. A method according to claim 46 further comprising:
receiving said content in a third format;
modifying said content into a fourth format dependent on said performance parameter;
transmitting said modified content.

57. A method according to claim 56 wherein said first and third content format are the same, and wherein said second and fourth content format are the same.

58. A processor code for controlling a processor in order to carry out a method according to claim 33.

59. A computer program product comprising code according to claim 58.

60. A processor code for controlling a processor in order to carry out a method according to claim 46.

61. A computer program product comprising code according to claim 60.
